(19) United States
(12) Patent Application Publication
(10) Pub. No.: US 2009/0224135 A1
(43) Pub. Date: Sep. 10, 2009

(54) MOLD UNIT WITH REPLACEABLE MOLD CORE HOLDER

(75) Inventor: CHIEN-FENG HUANG, Tu-Cheng (TW)

Correspondence Address: PCE INDUSTRY, INC.;ATT. Steven Reiss, 458 E. LAMBERT ROAD, FULLERTON, CA, 92835, US

(73) Assignee: HON HAI PRECISION INDUSTRY CO., LTD., Tu-Cheng (TW)

(21) Appl. No.: 12/240,415

(22) Filed: Sep. 29, 2008

(30) Foreign Application Priority Data
Mar. 6, 2008 (CN) 200810300480.8

(51) Int. Cl. B29C 33/00

(52) U.S. Cl. 249/64

(57) ABSTRACT

A mold unit includes a fixing plate, a mold core retaining plate mounted on the fixing plate, a plurality of mold core holders and a plurality of mold cores. The molding core retaining plate includes a first surface, an opposing second surface facing toward the fixing plate, and a plurality of receiving holes defined therein. The mold core holders are detachably engaged in the respective receiving holes. Each of the mold core holders includes a receiving cavity defined therein. The mold cores are respectively received in the receiving cavities of the mold core holders and are fixable to the fixing plate via the mold core holders. Each of the mold cores includes a molding surface adjacent to the first surface of the mold core retaining plate.

### BACKGROUND

1. Field of the Invention

The present invention relates to an injection molding apparatus, and particularly to a mold unit applicable in an injection molding apparatus that has individual replaceable mold core holders.

2. Description of Related Art

Many kinds of workpieces need to be made via molds. Mold cores are widely used in many mold units to configure workpieces. Referring to FIG. 4, a related molding apparatus 10 including a lower mold unit 11 and an upper mold unit 12 facing the lower mold unit 11 is shown. The lower mold unit 11 has a lower mold base 111, a plurality of lower mold cores 112 disposed within the lower mold base 111, and a lower fixing base 113 to be fixed to a bottom portion of the lower mold base 111 to retain the lower mold cores 112 in the lower mold base 111. The lower mold base 111 is formed with a plurality of lower mold core holes 114, each of which has a narrow upper portion and a wide lower portion. Each of the lower mold cores 112 has a shape corresponding to that of a respective one of the lower mold core holes 114, and forms a lower molding surface 115 at an end facing the upper mold base 121. After the lower mold cores 112 are inserted respectively into the lower mold core holes 114, the lower fixing base 113 is secured to the bottom portion of the lower mold base 111 so that the lower mold cores 112 are retained in the lower mold core holes 114.

The upper mold unit 12 has an upper mold base 121, a plurality of upper mold cores 122 disposed within the upper mold base 121, and an upper fixing base 123 to be fixed to a top portion of the upper mold base 121 to retain the upper mold cores 122 in the upper mold base 121. The upper mold base 121 is formed with a plurality of upper mold core holes 124, each of which has a narrow lower portion and a wide upper portion. Each of the upper mold cores 122 has a shape corresponding to that of a respective one of the upper mold core holes 124, and forms an upper molding surface 125 at an end facing the lower mold base 111. After the upper mold cores 122 are inserted respectively into the upper mold core holes 124, the upper fixing base 123 is secured to the top portion of the upper mold base 121 so that the upper mold cores 122 are retained in the upper mold core holes 124. When the molding apparatus 10 is in use, the upper mold unit 12 abuts against the lower mold unit 11, and thus a chamber is defined by each upper molding surface 125 of the upper mold cores 122, an inner surface face 116 of the upper mold base 121, an inner surface face 126 of the lower mold base 111 and the corresponding lower molding surface 115 of the lower mold core 112 for configuring the workpieces.

When the lower molding surface 115 or the upper molding surfaces 125 is damaged, the defective lower or upper mold core 112, 122 can be removed and replaced. However, if the inner surface 116 of the lower mold base 111 or the inner surfaces 126 of the upper mold base 121 is damaged, the lower mold base 111 or the upper mold base 121 is needed to be replaced. Removal and replacement operations of the lower mold base 111 or the upper mold base 121 are not only time consuming, but also heavily increase the maintenance cost of the molding apparatus 10.

What is needed, therefore, is an improved molding apparatus which can overcome the problems described.

### SUMMARY

A mold unit includes a fixing plate, a mold core retaining plate mounted on the fixing plate, a plurality of mold core holders and a plurality of mold cores. The molding core retaining plate includes a first surface, an opposing second surface facing toward the fixing plate, and a plurality of receiving holes defined therein. The mold core holders are detachably engaged in the respective receiving holes. Each of the mold core holders includes a receiving cavity defined therein. The mold cores are respectively received in the receiving cavities of the mold core holders and are fixable to the fixing plate via the mold core holders. Each of the mold cores includes a molding surface adjacent to the first surface of the mold core retaining plate.

Other advantages and novel features will become more apparent from the following detailed description of embodiments when taken in conjunction with the accompanying drawings.

### BRIEF DESCRIPTION OF THE DRAWINGS

FIG. 1 is an isometric, assembled view of an exemplary embodiment of a mold unit.

FIG. 2 is an isometric, exploded view of the mold unit in FIG. 1.

FIG. 3 is a schematic, cross-sectional view of the mold unit in FIG. 1, taken along line III-III.

FIG. 4 is a partly sectional exploded schematic view of a related molding apparatus.

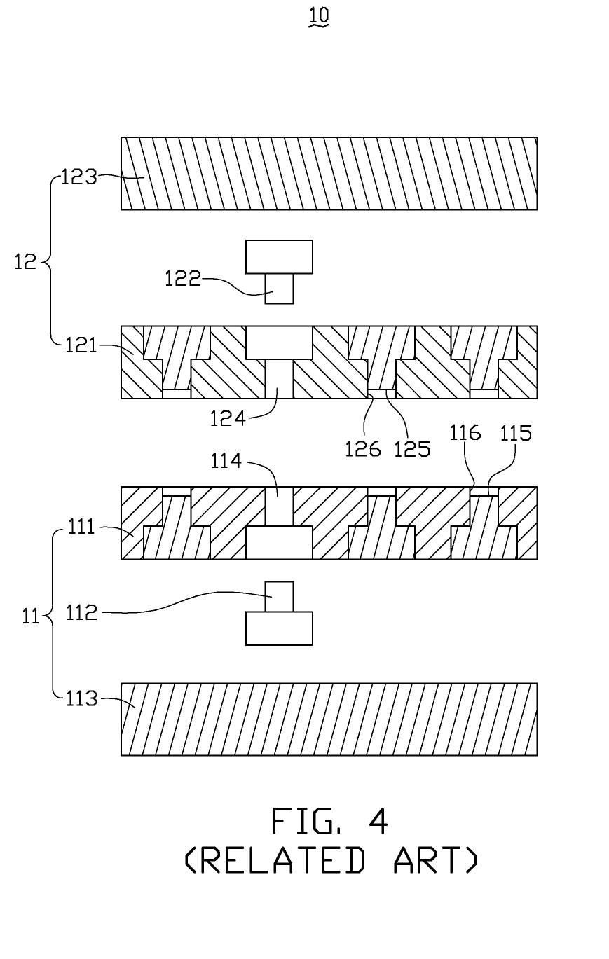

### DETAILED DESCRIPTION

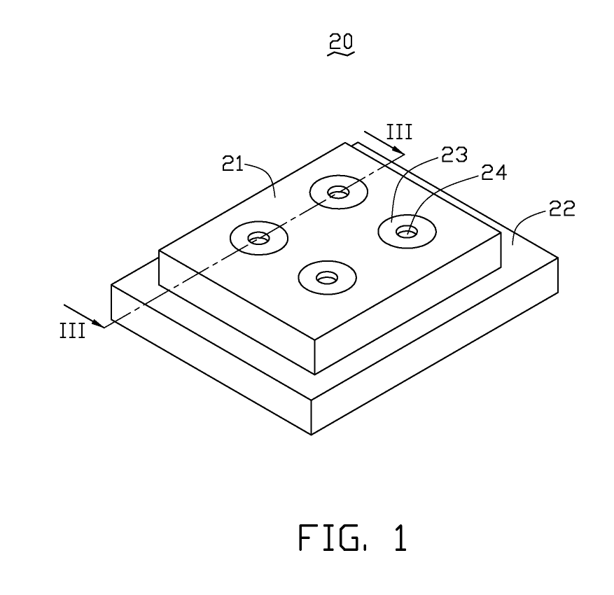

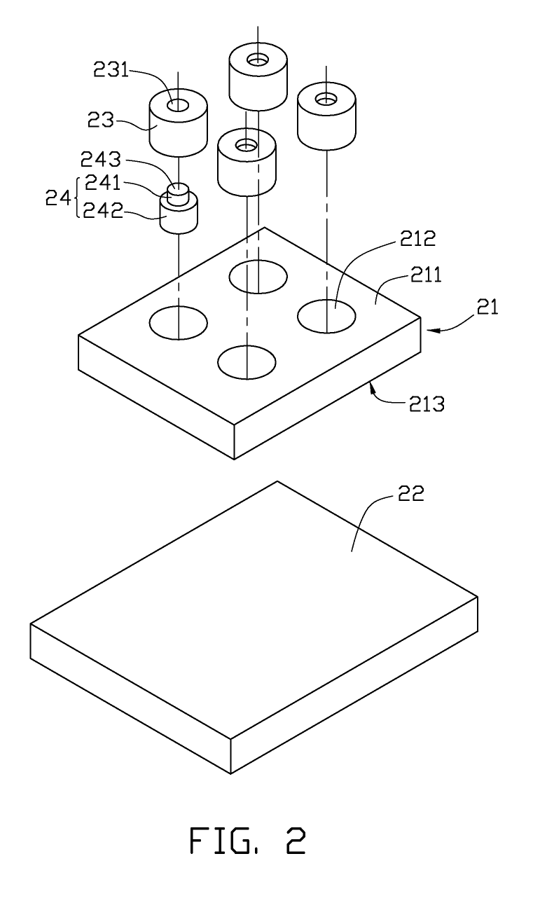

FIGS. 1-2 show an exemplary embodiment of a mold unit 20 that includes a mold core retaining plate 21, a fixing plate 22, a plurality of mold core holders 23 and a plurality of mold cores 24.

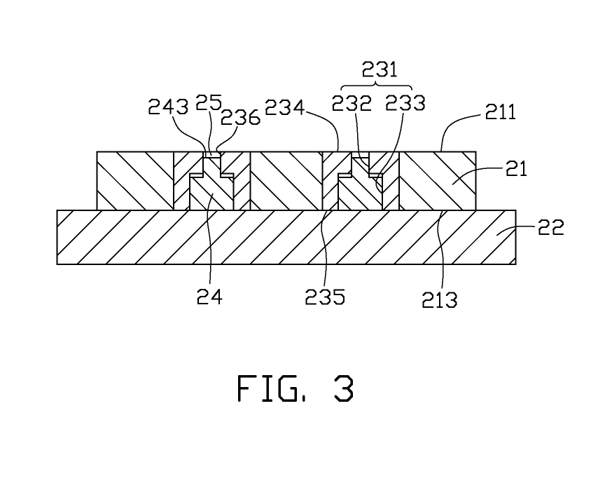

Referring also to FIG. 3, the mold core retaining plate 21 includes a parting surface 211 (i.e., first surface) and an opposing fixing surface 213 (i.e., second surface) facing toward the fixing plate 22. Four cylindrical shaped receiving holes 212 are defined in the mold core retaining plate 21 for receiving the corresponding mold core holders 23 therein. The four receiving holes 212 are arranged in a rectangular array. Each of the four receiving holes 212 extends through the mold core retaining plate 21 from the fixing surface 213 to the parting surface 211.

The mold core holder 23 is cylindrical corresponding to the receiving hole 212. An outer diameter of the mold core holder 23 is slightly greater than that of the receiving hole 212 of the mold core retaining plate 21. The mold core holder 23 includes a first end surface 234 and an opposing second end surface 235. When the mold core holder 23 is mounted into the receiving hole 212 of the mold core retaining plate 21, the first end surface 234 of the mold core holder 23 is flush with the parting surface 211 and the second end surface 235 of the mold core holder 23 is flush with the fixing surface 213 of the mold core retaining plate 21. A receiving cavity 231 is defined axially in each mold core holder 23 and extends downwardly from the first end surface 234 to the second end surface 235 of the mold core holder 23. The receiving cavity 231 includes a first cavity portion 232 adjacent to the first end surface 234 of the mold core holder 23, and a second cavity portion 233 adjacent to the second end surface 235. The first cavity portion 232 and the second cavity portion 233 are cylindrical and coaxial. A diameter of the first cavity portion 232 is less than that of the second cavity portion 233. An inner surface 236 of the base 21 surrounds the receiving cavity 231, and includes an upper portion and a lower portion with a diameter greater than that of the upper portion. A step is thus formed between the upper portion and the lower portion of the inner surface 236 of the mold core holder 23.

The mold core 24 includes a main body 242 and a raised portion 241 extending upwardly from a top surface of the main body 242. The main body 242 and the raised portion 241 are coaxial cylinders, and the raised portion 241 is coaxially with the main body 242. A diameter of the raised portion 241 is substantially equal to that of the first cavity portion 232, and a diameter of the main body 242 is substantially equal to that of the second cavity portion 233, thereby facilitating respective precision slide fits of the first cavity portion 232 and the second cavity portion 233. Furthermore, a height of the main body 242 is approximately the same as a depth of the second cavity portion 233, whilst a height of the raised portion 241 is less than a depth of the first cavity portion 232, i.e., a height of each mold core 24 is less than a depth of the receiving cavity 231. A molding surface 243 is formed at a free end of the raised portion 241. The molding surface 243 of each mold core 24 is lower than the parting surface 211 of the mold core retaining plate 21. The molding surface 243 can be formed as a concave surface, convex surface, or a planar surface according to the desired shape of the workpieces to be formed.

In assembly, the mold core holders 23 are detachably engaged in the respective receiving holes 212. The mold core holders 23 can be mounted to the mold core retaining plate 21 in a press-fit manner. In this embodiment, the mold core holders 23 are mounted to the mold core retaining plate 21 by temperature difference assembly method, i.e., the mold core holders 23 are mounted into the receiving holes 212 of the mold core retaining plate 21 by heating the mold core retaining plate 21 to expand dimensions of the receiving holes 212, or by cooling the mold core holders 23 to shrink dimensions of the mold core holders 23. The raised portion 241 and the main body 242 of the mold core 24 are received in the first cavity portion 232 and the second cavity portion 233, respectively. The fixing plate 22 is then mounted to the mold core retaining plate 21 and abuts against the fixing surface 213 of the mold core retaining plate 21. The fixing plate 22 can prevent the mold cores 24 from falling off. Each of the mold cores 24 received in the receiving holes 212 of the mold core retaining plate 21 has a bottom end abutting the fixing plate 22. Since the height of the raised portion 241 is less than the depth of the first cavity portion 232 of the mold core holder 23, the molding surface 243 of each mold core 24 is lower than the first end surface 234 of the mold core holder 23. The molding surface 243 of each mold core 24 and the inner surface 236 in the receiving hole 212 of a corresponding mold core holder 23 cooperatively define a mold cavity 25 for molding a workpiece. In use, a pair of mold units 20 are arranged facing each other with the parting surfaces 211 thereof abutting against each other. A chamber according to a size of the workpiece is defined between each two corresponding molding surfaces of the two mold units 20. When one of the inner surfaces 236 of the mold core holders 23 of the mold unit 20 is damaged, the damaged or defective mold core holder 23 can be detached easily from the mold core retaining plate 21 by temperature difference, i.e., by cooling the damaged or defective mold core holder 23 to shrink dimensions of the mold core holder 23.

Because the mold cavity 25 of the present embodiment is formed by the inner surface 236 of the mold core holder 23 and the molding surfaces 243 of the mold cores 24, when the inner surface 236 of mold core holder 23 is damaged or defective, only mold core holder 23 need to be replaced. The replacement time and the maintenance cost of the mold unit 20 are reduced.

It is to be further understood that even though numerous characteristics and advantages of the present embodiments have been set forth in the foregoing description, together with details of the structures and functions of the embodiments, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A mold unit, comprising:
a fixing plate;
a mold core retaining plate mounted on the fixing plate, the molding core retaining plate comprising a first surface, an opposing second surface, and a plurality of receiving holes defined therein, the second surface thereof facing toward the fixing plate;
a plurality of mold core holders detachably engaged in the respective receiving holes, each of the mold core holders comprising a receiving cavity defined therein; and
a plurality of mold cores respectively received in the receiving cavities of the mold core holders and fixable to the fixing plate via the mold core holders, each of the mold cores comprising a molding surface adjacent to the first surface of the mold core retaining plate.

2. The mold unit of claim 1, wherein a height of each mold core is less than a depth of the receiving cavity, and the molding surface of each mold core is lower than the first surface of the mold core retaining plate, thereby the molding surface of each mold core and an inner surface in the receiving hole of a corresponding mold core holder cooperatively defining a mold cavity.

3. The mold unit of claim 2, wherein each of the receiving cavities extends through the mold core holder, and includes a first cavity portion and a second cavity portion with a diameter greater than that of the first portion, and each of the mold cores includes a main body received in the second cavity portion and a raised portion received in the first cavity portion, the molding surface being formed on an outer surface of the raised portion.

4. The mold unit of claim 3, wherein the main body and the raised portion are coaxial cylinders, and the first cavity portion and the second cavity portion are cylindrical and coaxial.

5. The mold unit of claim 4, wherein a diameter of the raised portion is substantially equal to that of the first cavity portion of the mold core holder, and a diameter of the main body is substantially equal to that of the second cavity portion of the mold core holder.

6. The mold unit of claim 1, wherein the plurality of receiving holes includes four receiving holes arranged in a rectangular array.

7. The mold unit of claim 1, wherein each of the mold core holders has a same configuration as that of the corresponding receiving hole.

8. The mold unit of claim 1, wherein the receiving hole extends through the mold core retaining plate, each mold core holder comprising a first end surface and an opposing second end surface, each first end surface being flush with the first surface of the mold core retaining plate, and each second end surface being flush with the second surface of the mold core retaining plate.

9. The mold unit of claim 1, wherein each of the mold core holders has a diameter greater than that of the receiving hole, and is interferentially mounted in the receiving holes of the mold core retaining plate.

10. A mold unit, comprising:
a fixing plate;
a mold core retaining plate mounted on the fixing plate, the mold core retaining plate having a fixing surface attached to the fixing plate and a parting surface opposite to the parting surface, at least one receiving hole extending through the mold core retaining plate;
at least one mold core holder received in the receiving hole of the mold core retaining plate, the mold core holder comprising a first end surface flush with the parting surface of the mold core retaining plate and a second end surface flush with the fixing surface of the mold core retaining plate, at least one receiving cavity defined in the first end surface of the at least one mold core holder; and
at least one mold core received in the at least one receiving cavity of the core holder, the at least one mold core forming a molding surface at an end thereof adjacent to the parting surface, the molding surface of the at least one mold core and an inner surface in the at least one receiving cavity of the at least one mold core holder cooperatively defining a mold cavity.

11. The mold unit of claim 10, wherein the at least one mold core holder has a diameter greater than that of the at least one receiving hole, and is interferentially mounted to the mold core retaining plate.

12. The mold unit of claim 10, wherein the at least one receiving cavity includes a first cavity portion and a second cavity portion communicating with the first cavity portion, and the at least one mold core includes a main body received in the second cavity portion and a raised portion received in the first cavity portion.

13. The mold unit of claim 12, wherein the first cavity portion is adjacent to the parting surface of the mold core retaining plate and the second cavity portion is adjacent to the fixing surface, and a diameter of the first cavity portion is less than that of the second cavity portion.

14. The mold unit of claim 13, wherein a height of the raised portion is less than a depth of the first cavity portion.
